(19) United States
(12) Patent Application Publication
(10) Pub. No.: US 2016/0311375 A1
(43) Pub. Date: Oct. 27, 2016

(54) VEHICLE VISION SYSTEM WITH EXCHANGEABLE CAMERAS

(71) Applicant: MAGNA ELECTRONICS INC., Aubum Hills, MI (US)

(72) Inventor: Michael Biemer, Aschaffenburg-Obernau (DE)

(21) Appl. No.: 15/134,441

(22) Filed: Apr. 21, 2016

Related U.S. Application Data
(60) Provisional application No. 62/150,471, filed on Apr. 21, 2015.

(51) Int. Cl. B60R 1/00; H01R 33/00; H01R 33/72; G06K 9/00

(52) U.S. Cl. CPC B60R 1/00; G06K 9/00791; H01R 33/00; H01R 33/72; B60R 2300/105

(57) ABSTRACT

A vision system of a vehicle includes a camera receiving socket fixedly disposed at an exterior portion of a vehicle. The camera receiving socket includes a socket electrical connector that is electrically connected to a wire harness of the vehicle. A camera assembly includes a lens and imager and associated circuitry, and includes a camera body that is configured to removably attach at the camera receiving socket. The camera assembly includes a camera electrical connector electrically connected to the circuitry. When the camera body is attached at the camera receiving socket, the camera body mechanically attaches at the camera receiving socket to detachably retain the camera assembly at the vehicle and the camera electrical connector is electrically connected to the socket electrical connector. When the camera body is detachably attached at the camera receiving socket, the camera assembly has a field of view exterior of the vehicle.

### CROSS REFERENCE TO RELATED APPLICATION

The present application claims the filing benefits of U.S. provisional application Ser. No. 62/150,471, filed Apr. 21, 2015, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties. Cameras for such vision systems are fixedly mounted at the vehicle, such as at an exterior portion of the vehicle, such as at a forward or rearward or sideward portion of the vehicle.

It is known for OEM vehicle cameras to have connectors with power and signal lines. The vehicle wire harness and its connectors are designed to be sealed by itself or when joined by the according counter connector or device plug. The camera body is typically fixedly attached, such as via screws or riveting or attached by a jacket which itself is attached to the vehicle body by form fit, clipping, gluing, screwing or riveting. For example, surround view vision cameras may be embedded or mounted at the vehicle exterior rearview mirror assembly housing, with the lens top exposed at the outside while the camera is hidden in the mirror housing, including its fixations and harness. An example of a known surround view fisheye camera assembly or module fixedly disposed at or mounted in exterior rearview mirror assembly is shown in FIG. 2.

### SUMMARY OF THE INVENTION

The present invention provides a vision system or imaging system for a vehicle that utilizes one or more cameras (preferably one or more CMOS cameras) to capture image data representative of images exterior of the vehicle, and provides an exchangeable or replaceable camera that is removable from and attachable at a socket or housing fixedly attached at the vehicle. The socket or housing is fixedly disposed at an exterior portion of the vehicle (such as at a housing of an exterior rearview mirror assembly or such as at a front or rear bumper of the vehicle or the like), and the camera is configured to attach at the socket so as to be fixed at the vehicle. The camera body and socket may have retaining means (such as a bayonet connection or a press fit connection or screw in or threaded connection or snap fit connection or fastenerless connection or the like) that retains the camera at a desired or appropriate location and orientation at the socket and at the exterior portion of the vehicle when the camera body is received in and retained at the socket.

The present invention thus provides a low cost replaceable camera that can be readily replaced if damaged or broken during use of the camera at the vehicle. Because the camera can be readily replaced, the camera need not be as robust as current OEM cameras, such that the camera may comprise a lower cost camera that may also provide enhanced resolution and performance. The camera, due to the fixed location of the socket, is (when retained at the socket) retained at an appropriate location and orientation at the exterior portion of the vehicle, such that calibration of the camera is minimal and can be done via image processing after the camera is replaced.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a sectional view of an exterior rearview mirror assembly having an exchangeable camera in accordance with the present invention;

FIG. 3 is a perspective view of an exchangeable camera as it is being connected to a mount and connector in accordance with the present invention;

FIG. 4 is a perspective view of the camera connector of FIG. 3;

FIG. 5 is a perspective view of an exchangeable camera of the present invention;

FIG. 6 is an enlarged sectional view of an exchangeable camera connected to a mount and connector in accordance with the present invention;

FIG. 7 is a sectional view of another exterior rearview mirror assembly having another exchangeable camera in accordance with the present invention;

FIG. 7A is an enlarged sectional view of the exchangeable camera connected to the mount and connector of the exterior rearview mirror assembly of FIG. 7;

FIG. 8A is a perspective view image of a demonstrator of an ultra-high speed data wireless connection device G-Link;

FIG. 8B is a perspective view image of a transponder chip of an ultra-high speed data wireless connection device G-Link; and

FIG. 8C is a perspective view image of an installed transponder chip of an ultra-high speed data wireless connection device G-Link.

### Legend:

20 disposable camera
21 peg
22 coaxial connector structure on camera
23 camera receiving socket
24 bayonet snap in groove
25 coaxial connector structure on socket
26 power pin spring connector
27 wire harness connector to camera receiving socket
28 wire harness
29 power connector pads

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may comprise a plurality of cameras that cooperate to provide a top down or bird's eye or surround view display and may provide a displayed image that is representative of the subject vehicle, and optionally with the displayed image being customized to at least partially correspond to the actual subject vehicle.

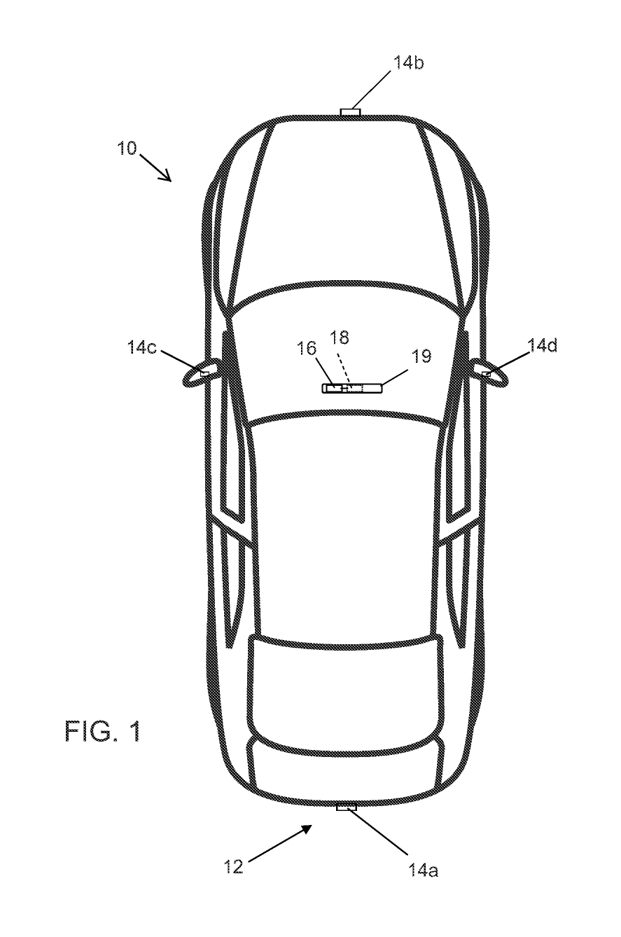

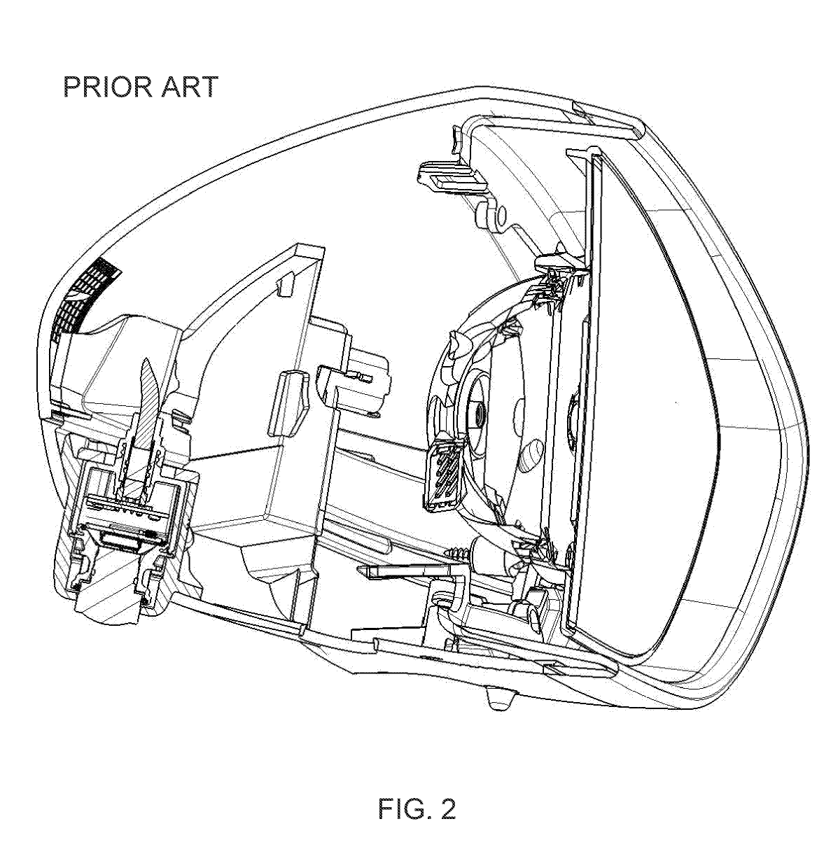

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) or processor 18 that is operable to process image data captured by the camera or cameras and may detect objects or the like and/or provide displayed images at a display device 16 for viewing by the driver of the vehicle (although shown in FIG. 1 as being part of or incorporated in or at an interior rearview mirror assembly 19 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

The system may comprise a plurality of cameras assembled on and in a vehicle body, such as by utilizing aspects of the systems described in U.S. Publication No. US-2014-0168415, which is hereby incorporated herein by reference in its entirety. In there it was suggested to arrange and process the image data of several separated single cameras to generate a (Stanford—) light field of the vehicle's environment.

The use of wafer level cameras in automotive vision systems was suggested in International Publication No. WO 2013/081985, which is hereby incorporated herein by reference in its entirety. In U.S. Publication No. US-2014-0168415 (incorporated above), the usage of wafer level cameras as light field cameras was described as an option.

Highly compact, high resolution smart phone cameras with reasonable optical performance and high end image processing capabilities may possess a wide range of features such as HDR, image stabilization (opto-mechanically or electronically), local tone mapping, night vision capability and efficient pixel noise filters. Many have digital zoom, some have optical zoom. Some have lens array based light field cameras. Some have optical focus capabilities.

Fixedly applied vehicle electronics (OEM—) vehicle cameras have to comply with automotive requirements. This includes requirements concerning durability due to humidity and temperature influences, mechanical shock, induced electromagnetic disturbances, cable bound electromagnetic disturbances, durability against electric shocking, such as electromagnetic discharges, supply or signal under-voltage and over-voltage or ground shift. Other requirements apply concerning Software quality, functional safety (ASIL), production trackability and minimal production quality standards, besides special requirements depending on the particular application for which the camera is dedicated.

In contrast to OEM electronics, aftermarket electronics including aftermarket cameras do not have to comply with many of the OEM-electronics requirements, especially when not safety relevant.

Automotive OEM cameras are always fixedly assembled and installed to the equipped vehicle when at the vehicle assembly line. Little to no efforts are done by the Tier one suppliers or OEMs to open the possibility to easily exchange, add or upgrade a vehicle camera after vehicle assembly. Exchanges or replacements of broken cameras are meant to be executed by qualified vehicle repair shops. Even technically advanced vehicle owners have difficulties replacing a broken surround view vision vehicle camera with a spare camera, due to insufficient calibration capabilities.

Due to hard automotive requirements and comparably small numbers in parts, nowadays there are practically no automotive grade imagers exceeding 2 MP available to Tier-1 suppliers, while in the consumer market, cameras which do not comply with such hard requirements such as handheld photo cameras and smart phones have imagers up to 20 MP (for example, the Sony Xperia Z3) and more (for example, the Nokia Lumia 1020).

Due to higher volumes, the used optics for smart phones have at least comparable quality compared to typical automotive camera optics, while its costs are lower (when comparing non fisheye lens optics, not normal focal range such as like 50 mm). Smartphone camera optics are already considerably smaller. The electronics body may be smaller since the image processing may mostly be done in the smart phone processor, but typically the integration level of smart phone image processing chips is more advanced and due to that cheaper and more compact.

The present invention provides an exchangeable or replaceable vehicle camera that may be readily replaced at the vehicle. Vehicles may be equipped with (disposable) cameras having a plug interface for making vehicle cameras interchangeable. The changing may be as easily as when changing a light bulb at the vehicle. Thus, it is easy enough to leave the changing to the car owner or service attendant at a filling station with no expertise required. The change procedure may be described in the vehicle service hand book.

The cameras being used at the vehicle line and as spare cameras (for being changed by the car owner himself) may be cheap, mass produced cameras comparable to the set-up and quality of smart phone cameras. Simple smart phone cameras typically comprise imager electronics, a fixed lens stack with fixed aperture at about f=2.0. The cameras and their imagers and image processing chips may be less durable than current OEM automotive cameras. By that high resolution (for example, at least around 5 MP or around 10 MP or more) and high integration levels such as to find in smart phone cameras may be achievable.

The OEM vehicle cameras may have pin connectors with power and signal lines as well as coaxial cable connectors with separate power connector (with pins) or coaxial cable connectors with power and signal transmission via the coaxial connector together.

The exchangeable, disposable camera of the present invention may be attached to an according camera receiving socket which is comparably well accessible. To detach the camera, no joints or fasteners (or just one or a few of joints or fasteners) may have to be detached, preferably with no need of tools. The electrical connection may join by inserting and optionally locking the camera to the camera socket. Optionally, the electrical connection structure will sit in the center of the socket (for being rotation symmetrical). The socket itself may be permanently connected to vehicle wire harness, in a manner comparable to the manner conventional vehicle cameras are assembled nowadays. Preferably, the socket may be sealed.

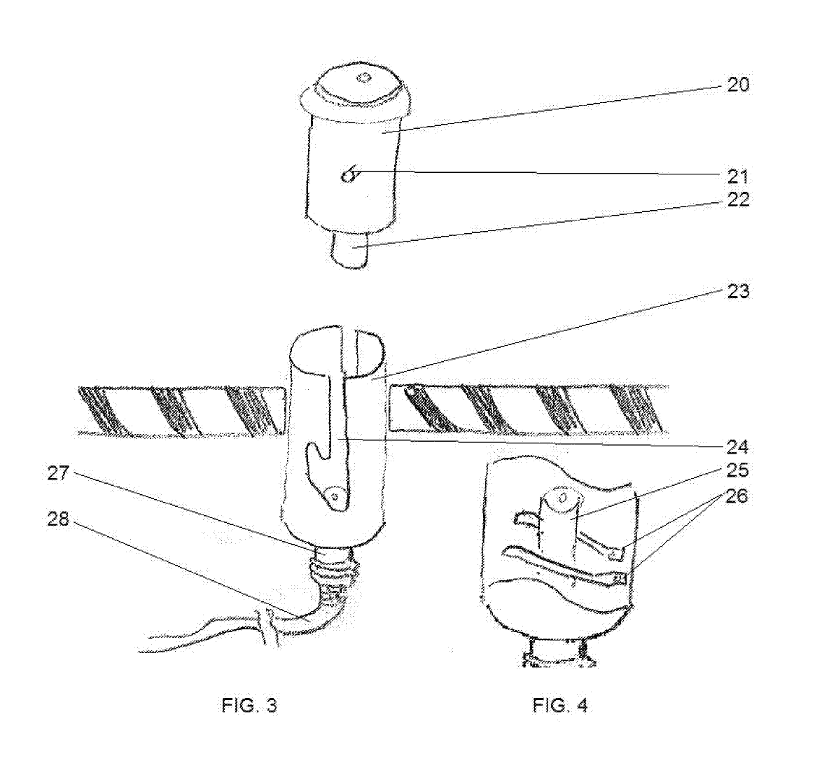

The camera locking may be done by form fitting optionally in conjunction with an elastic (such as, for example, a spring) element (see FIG. 3). In the illustrated embodiment of FIG. 3, the camera 20 has a pin or post or peg protruding from opposite sides of the camera body, whereby the pins 21 are received in respective channels or grooves 24 of the camera receiving socket 23. When the camera is seated in the socket, the camera is rotated to move the pins into receiving or retaining portions of the grooves to substantially lock or retain the camera at the socket. When so retained, the coaxial connector structure 22 on the camera is electrically connected to the coaxial connector structure 25 of the socket. The socket connector 25 is electrically connected to a wire harness connector to camera receiving socket 27, which electrically connects to a vehicle wiring harness 28, such as via a coaxial connector or multi-pin connector or the like. The electrical connection of the camera electrical connector to the socket electrical connector may comprise at least a ground line, a power and a video signal line. Optionally, the electrical connection of the camera electrical connector to the socket electrical connector may comprise a communication line to a communication bus of the vehicle.

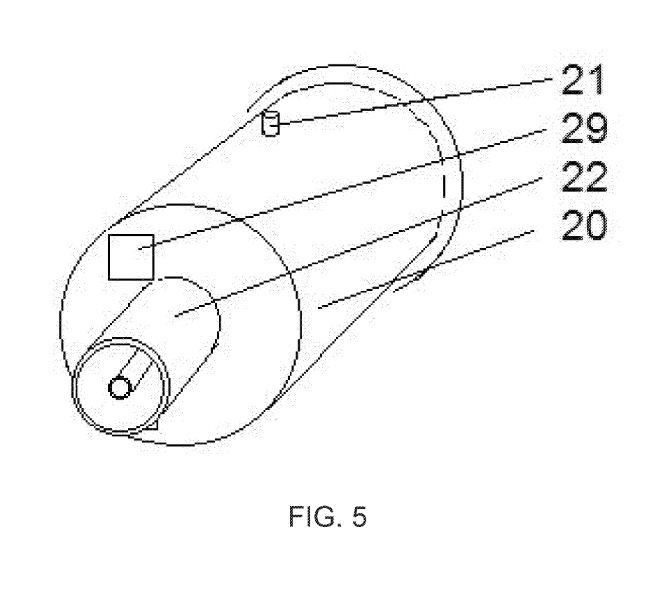

Optionally, the elastic element is commonly used as electrical conducting element between the camera and socket (see FIG. 4). FIG. 5 shows a close up of a camera according to the present invention. Optionally, the camera may be fixated in the socket by a fixation hook, catch, lever or clip. Optionally, the camera may be fixated in the socket by an overthrow ring which itself is fixated to a screwing spiral, bayonet structure or by a hook, catch, lever or clip. Optionally, the camera according the invention may have a bayonet lock within the socket (such as shown in FIG. 3). Optionally, the camera according the invention may be locking be press fit. Optionally, the camera according the invention may be screwed into a threaded socket. Optionally, the camera according the invention may be hold by an elastic O-ring element which is pressed into the gap between camera and camera socket when applying the optional fixation hook, catch, lever or clip.

Optionally, when connected or retained at the socket, the camera interface may be one of a type of BA 9, BAY 15D, GU10, GU5.3, G4, RCA of any type, E27, E14, T5, MP-371, MJ-372, TM 0508 A, DIN 41524, DIN 45322, DIN 45322, DIN 45329 or DIN 45326 or the like.

Optionally, the sealing to the camera will be closed or sealed by inserting the camera. Optionally, the camera may have a sealing structure which aligns with the socket structure when inserting the camera. Optionally, the socket will carry the sealing structure. Optionally, the camera and the socket will have a sealing structure which optionally seal when engaged and joined or double seal each independently.

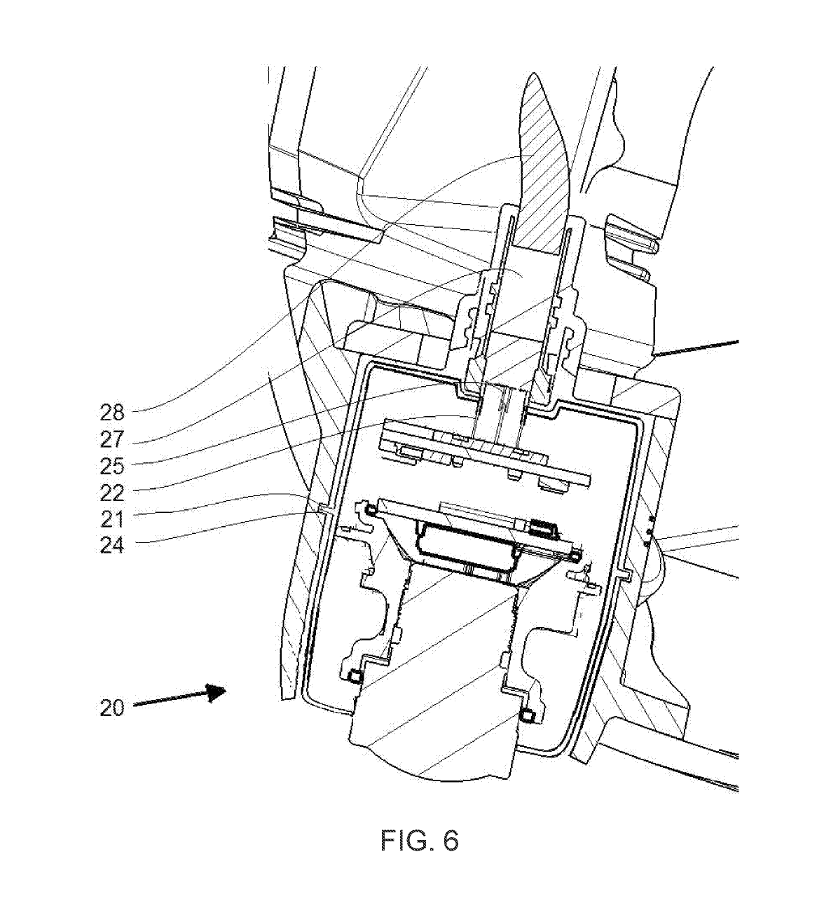

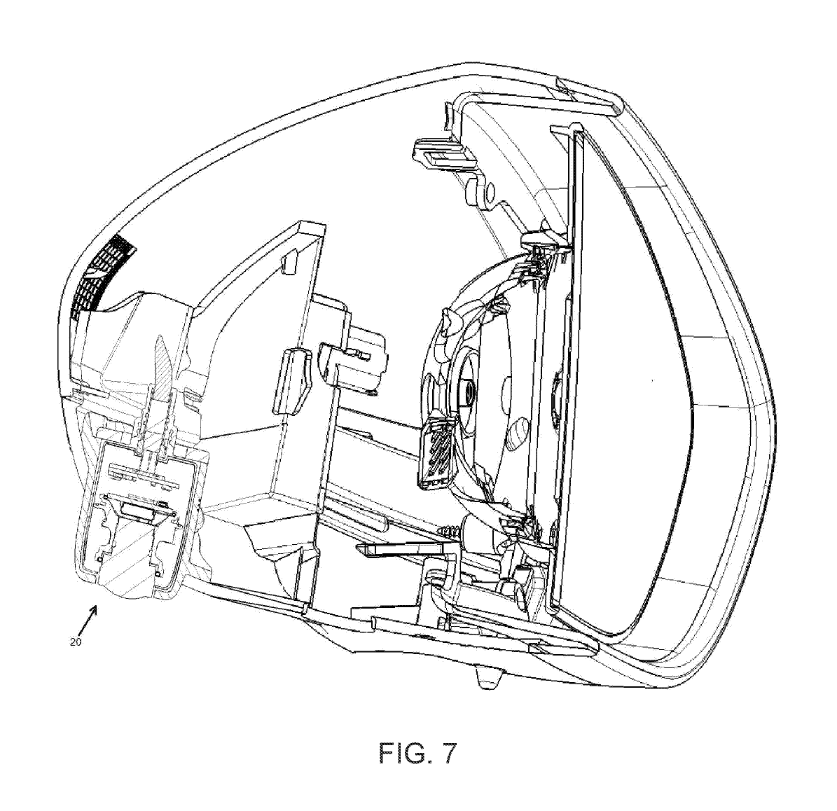

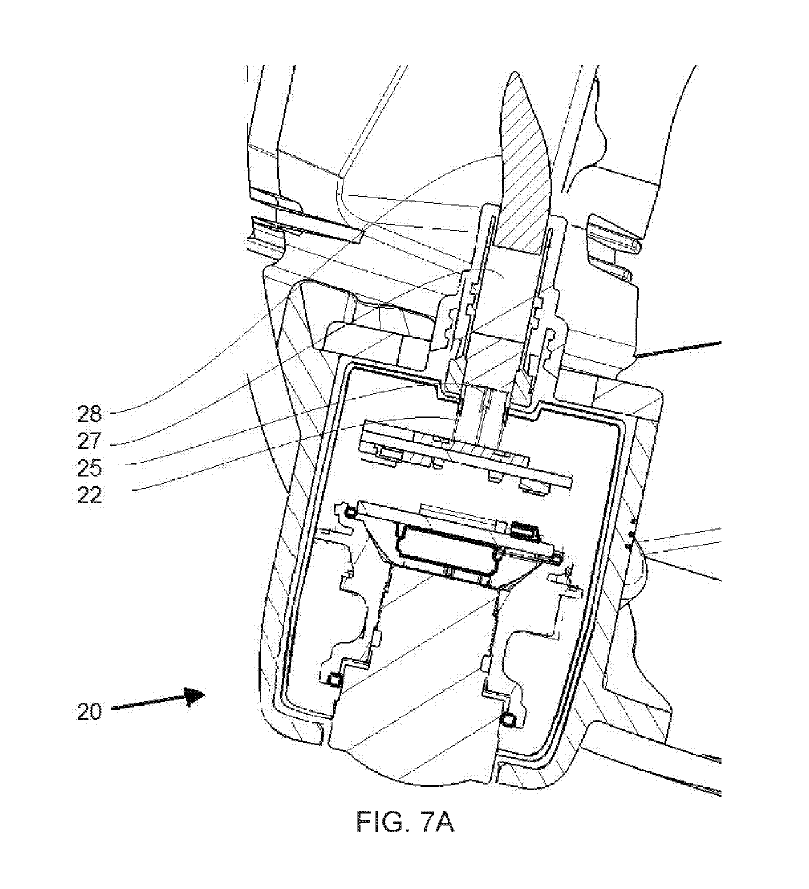

FIG. 6 shows a camera 20 according to the present invention having a coaxial bottom connector 22 to a coaxial socket 25 which is at the bottom of a jacket like structure enclosing the camera within the mirror assembly. In FIG. 6, the camera and socket has a bayonet fixation structure (such as similar to that shown in FIGS. 3 and 5). As shown in FIGS. 7 and 7A, the camera may be fixed or retained by the socket form or shape. As shown in FIGS. 6, 7 and 7A, the camera 20 includes an imager and lens assembly, along with circuitry disposed at one or more circuit boards of the camera. The camera connector 22 is disposed at a circuit board of the camera and protrudes from or is exposed at the end of the camera body, such that the camera connector engages and connects to the socket connector when the camera body is received in the socket and retained therein.

Thus, the present invention provides a camera that is detachably or removably attached or received at a camera receiving socket or receptacle disposed at an exterior portion of a vehicle. The camera body is configured to be received at least partially in the camera receiving socket and retained therein. For example, the camera body may comprise at least one retaining element protruding radially outwardly therefrom, and the camera receiving socket may comprise at least one groove for receiving the at least one retaining element therein. The camera body, while in an inserting orientation relative to the camera receiving socket, is inserted into the camera receiving socket with the retaining element moving axially along the groove. The camera body is then retained in the camera receiving socket by rotation of the camera body relative to the camera receiving socket so that the at least one retaining socket moves radially along the at least one groove to a locking location or orientation of the camera relative to the camera receiving socket, whereby the camera receiving socket limits axial movement of the retaining element and the camera body relative to the camera receiving socket.

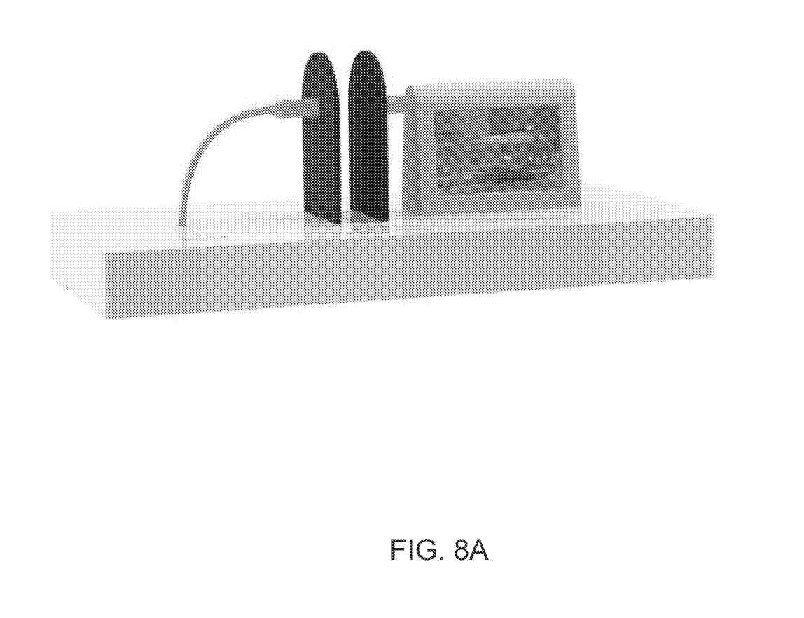

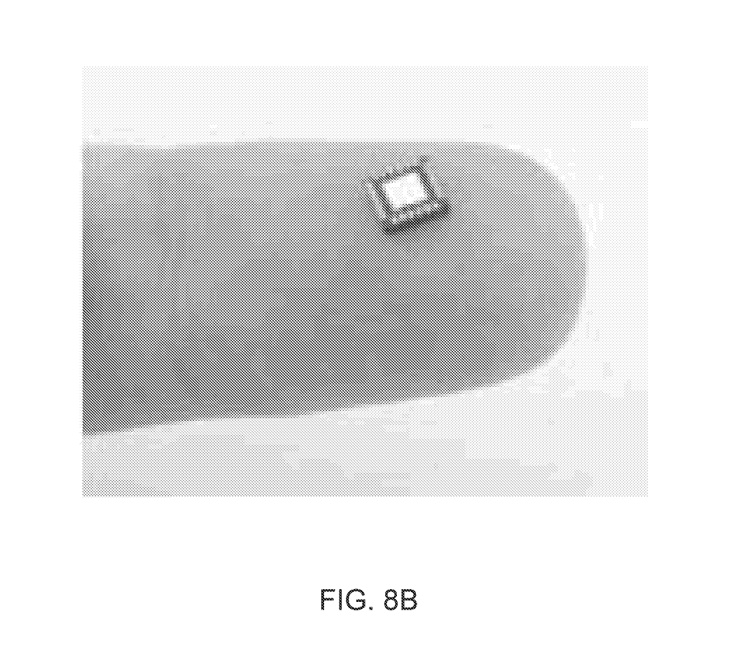

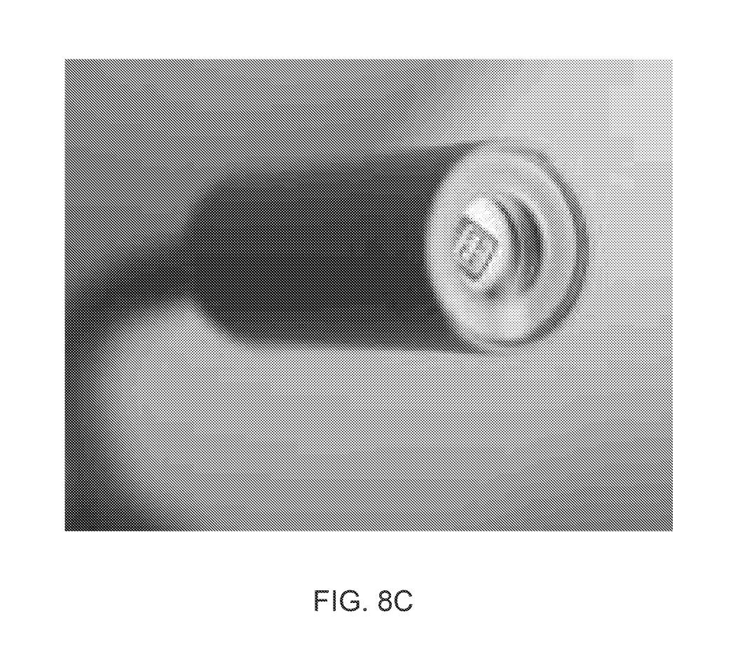

As an optional alternative of properties of the exchangeable cameras the above data link and optionally also the power link or connection may be done wirelessly. The camera's power may be induced by an HF or LF induction. The camera may have a coil or antenna structure to retain power from an antenna or coil within the socket structure. Optionally, the data communication may be done by near field. Optionally, an ultra-high speed data wireless connection (5 Gbps) at lower power consumption (50 mW) may come into use, such as by utilizing aspects of the G-Link devices (offered by Leti Cea Tech of France), which works with 60 Hz worldwide RF band and has low costs. FIGS. 8A, 8B and 8C show images from the G-Link product brochure, which is hereby incorporated herein by reference in its entirety.

Thus, the present invention provides an exchangeable or replaceable camera for a vehicle. The vehicle may have a socket or housing or camera receiving structure fixedly disposed at an exterior portion of the vehicle (such as at a housing of an exterior rearview mirror assembly or such as at a front or rear bumper of the vehicle or the like), and the camera body is configured to mechanically attach at the socket so as to be detachably fixed or retained at the vehicle. The camera body and receiving socket may have retaining means that retain the camera at a desired or appropriate location and orientation at the socket and at the exterior portion of the vehicle when the camera body is received in and retained at the socket. The camera receiving structure or socket is configured at the vehicle so as to at least in part define or set the field of view of the camera that is detachably attached at the camera receiving structure (such as being oriented with an axis that is generally vertical and angled outwardly away from the vehicle such as shown in FIG. 6). Thus, the camera, due to the fixed location of the socket, is retained at an appropriate location and orientation at the exterior portion of the vehicle, such that calibration of the camera is minimal and can be done via image processing after the camera is replaced.

The present invention thus provides a low cost replaceable camera that can be readily replaced if damaged or broken during use of the camera at the vehicle. Because the camera can be readily replaced, the camera need not be as robust as current OEM cameras, such that the camera may comprise a lower cost camera that may also provide enhanced resolution and performance.

The camera or sensor may utilize aspects of any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. Publication No. US-2012-0062743, which are hereby incorporated herein by reference in their entireties.

The imaging device and control and image processor and any associated illumination source, if applicable, may comprise any suitable components, and may utilize aspects of the cameras (such as various imaging sensors or imaging array sensors or cameras or the like, such as a CMOS imaging array sensor, a CCD sensor or other sensors or the like) and vision systems described in U.S. Pat. Nos. 5,760,962; 5,715,093; 6,922,292; 6,757,109; 6,717,610; 6,590,719; 6,201,642; 5,796,094; 6,559,435; 6,831,261; 6,822,563; 6,946,978; 7,720,580; 8,542,451; 7,965,336; 7,480,149; 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454 and/or 6,824,281, and/or International Publication Nos. WO 2009/036176; WO 2009/046268; WO 2010/099416; WO 2011/028686 and/or WO 2013/016409, and/or U.S. Pat. Publication Nos. US 2010-0020170 and/or US-2009-0244361, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149 and/or 7,526,103, which are all hereby incorporated herein by reference in their entireties, a rain sensor, such as the types disclosed in commonly assigned U.S. Pat. Nos. 6,353,392; 6,313,454; 6,320,176 and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978 and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, which are hereby incorporated herein by reference in their entireties, a video device for internal cabin surveillance and/or video telephone function, such as disclosed in U.S. Pat. Nos. 5,760,962; 5,877,897; 6,690,268 and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the vision system may include a display for displaying images captured by one or more of the imaging sensors for viewing by the driver of the vehicle while the driver is normally operating the vehicle. Optionally, for example, the vision system may include a video display device, such as by utilizing aspects of the video display systems described in U.S. Pat. Nos. 5,530,240; 6,329,925; 7,855,755; 7,626,749; 7,581,859; 7,446,650; 7,338,177; 7,274,501; 7,255,451; 7,195,381; 7,184,190; 5,668,663; 5,724,187; 6,690,268; 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252 and/or 6,642,851, and/or U.S. Publication Nos. US-2012-0162427; US-2006-0050018 and/or US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249 and/or WO 2013/109869, and/or U.S. Publication No. US-2012-0162427, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera receiving socket fixedly disposed at an exterior portion of a vehicle, wherein said camera receiving socket includes a socket electrical connector that is electrically connected to a wire harness of the vehicle;
a camera assembly comprising a camera body, a lens and an imager and associated circuitry, wherein said camera body is configured to removably attach at said camera receiving socket, wherein said camera assembly comprises a camera electrical connector electrically connected to said circuitry;
wherein, when said camera body is attached at said camera receiving socket, (i) said camera body mechanically attaches at said camera receiving socket to detachably retain said camera assembly at the vehicle and (ii) said camera electrical connector is electrically connected to said socket electrical connector; and
wherein, with said camera body detachably retained at said camera receiving socket, said camera assembly has a field of view exterior of the vehicle.

2. The vision system of claim 1, wherein electrical connection of said camera electrical connector to said socket electrical connector comprises at least a ground line, a power and a video signal line.

3. The vision system of claim 1, wherein electrical connection of said camera electrical connector to said socket electrical connector comprises a communication line to a communication bus of the vehicle.

4. The vision system of claim 1, wherein said camera body and said camera receiving socket are configured to connect via a bayonet type connection.

5. The vision system of claim 1, wherein said camera body and said camera receiving socket are configured to connect via a press fit connection.

6. The vision system of claim 1, wherein said camera body and said camera receiving socket are configured to connect via a threaded connection.

7. The vision system of claim 1, wherein said camera body and said camera receiving socket are configured to connect via a snap fit connection.

8. The vision system of claim 1, wherein said camera body and said camera receiving socket are configured to connect via a fastenerless connection.

9. The vision system of claim 1, wherein said camera body is configured to be received at least partially in said camera receiving socket.

10. The vision system of claim 9, wherein said camera body comprises at least one retaining element protruding radially outwardly therefrom, and wherein said camera receiving socket comprises at least one groove for receiving said at least one retaining element therein, and wherein said camera body is retained in said camera receiving socket by rotation of said camera body relative to said camera receiving socket so that said at least one retaining socket moves along said at least one groove to a locking location that limits axial movement of said camera body relative to said camera receiving socket.

11. The vision system of claim 1, wherein said camera receiving socket is fixedly disposed at a housing of an exterior rearview mirror assembly of the vehicle.

12. The vision system of claim 1, wherein said camera assembly comprises a camera assembly of a surround view system of the vehicle.

13. A vision system of a vehicle, said vision system comprising:
a camera receiving socket fixedly disposed at an exterior portion of a vehicle, wherein said camera receiving socket includes a socket electrical connector that is electrically connected to a wire harness of the vehicle;
wherein said camera receiving socket is fixedly disposed at a housing of an exterior rearview mirror assembly of the vehicle;
a camera assembly comprising a camera body, a lens and an imager and associated circuitry, wherein said camera body is configured to removably attach at said camera receiving socket, wherein said camera assembly comprises a camera electrical connector electrically connected to said circuitry;
wherein, when said camera body is attached at said camera receiving socket, (i) said camera body mechanically attaches at said camera receiving socket to detachably retain said camera assembly at the vehicle and (ii) said camera electrical connector is electrically connected to said socket electrical connector;
wherein said camera body and said camera receiving socket are configured to connect via a fastenerless connection;
wherein, with said camera body detachably retained at said camera receiving socket, said camera assembly has a field of view exterior of the vehicle; and
wherein said camera assembly comprises a camera assembly of a surround view system of the vehicle.

14. The vision system of claim 13, wherein electrical connection of said camera electrical connector to said socket electrical connector comprises at least a ground line, a power and a video signal line.

15. The vision system of claim 13, wherein electrical connection of said camera electrical connector to said socket electrical connector comprises a communication line to a communication bus of the vehicle.

16. The vision system of claim 13, wherein said camera body and said camera receiving socket are configured to connect via one of (i) a bayonet type connection, (ii) a press fit connection, (iii) a threaded connection, and (iv) a snap fit connection.

17. The vision system of claim 13, wherein said camera body is configured to be received at least partially in said camera receiving socket, and wherein said camera body comprises at least one retaining element protruding radially outwardly therefrom, and wherein said camera receiving socket comprises at least one groove for receiving said at least one retaining element therein, and wherein said camera body is retained in said camera receiving socket by rotation of said camera body relative to said camera receiving socket so that said at least one retaining socket moves along said at least one groove to a locking location that limits axial movement of said camera body relative to said camera receiving socket.

18. A vision system of a vehicle, said vision system comprising:
a camera receiving socket fixedly disposed at an exterior portion of a vehicle, wherein said camera receiving socket includes a socket electrical connector that is electrically connected to a wire harness of the vehicle;
a camera assembly comprising a camera body, a lens and an imager and associated circuitry, wherein said camera body is configured to removably attach at said camera receiving socket, wherein said camera assembly comprises a camera electrical connector electrically connected to said circuitry;
wherein, when said camera body is attached at said camera receiving socket, (i) said camera body mechanically attaches at said camera receiving socket to detachably retain said camera assembly at the vehicle and (ii) said camera electrical connector is electrically connected to said socket electrical connector;
wherein said camera body is configured to be received at least partially in said camera receiving socket, and wherein said camera body comprises at least one retaining element protruding radially outwardly therefrom, and wherein said camera receiving socket comprises at least one groove for receiving said at least one retaining element therein, and wherein said camera body is retained in said camera receiving socket by rotation of said camera body relative to said camera receiving socket so that said at least one retaining socket moves along said at least one groove to a locking location that limits axial movement of said camera body relative to said camera receiving socket;
wherein, with said camera body detachably retained at said camera receiving socket, said camera assembly has a field of view exterior of the vehicle; and
wherein said camera assembly comprises a camera assembly of a surround view system of the vehicle.

19. The vision system of claim 18, wherein electrical connection of said camera electrical connector to said socket electrical connector comprises at least a ground line, a power and a video signal line.

20. The vision system of claim 18, wherein electrical connection of said camera electrical connector to said socket electrical connector comprises a communication line to a communication bus of the vehicle.
